(19) United States
(12) Patent Application Publication
(10) Pub. No.: US 2007/0146720 A1
(43) Pub. Date: Jun. 28, 2007

(54) Spectrometer method and apparatus for near infrared to terahertz wavelengths

(75) Inventors: James A. Cox, New Brighton, MN (US); Roland A. Wood, Bloomington, MN (US); Bernard S. Fritz, Eagan, MN (US); Fouad Nusseibeh, Champlin, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/350,541

(22) Filed: Feb. 9, 2006

Related U.S. Application Data
(60) Provisional application No. 60/753,643, filed on Dec. 23, 2005.

(51) Int. Cl. G01B 9/02; G01J 3/45

(52) U.S. Cl. 356/451

(57) ABSTRACT

In accordance with the principles of the invention, a lamellar grating interferometer breaks the radiation down into its wavelength components. The two sets of teeth of the grating are moved relative to each other. The spectral output of the interferometer is focused on an array of detectors and data is stored for a large number of positions of the grating teeth. The collected data is then Fourier transformed to recover the spectrum of the radiation.

### CROSS REFERENCE TO RELATED APPLICATION

The present application claims the benefit of U.S. Provisional Appln. No. 60/753,643 filed on Dec. 23, 2005. The content of the aforementioned application is fully incorporated by reference herein.

### FIELD OF THE INVENTION

The invention pertains to imaging and non-imaging spectrometers.

### BACKGROUND OF THE INVENTION

Spectroscopy is a scientific technique by which electromagnetic radiation from a given source is broken down into its wavelength components and those components are analyzed to determine physical properties of the source of that radiation. Particularly, the wavelengths of radiation that are (or are not) in the spectrum are indicative of the atoms or molecules that are in the source of the radiation. Spectrometers spread radiation out into its wavelength components, creating spectra.

Within these spectra, one can study emission and/or absorption lines, which are the fingerprints of atoms and molecules. Every atomic element in the periodic table of elements has a unique spacing of electron orbits and, therefore, can emit or absorb only certain energies or wavelengths. Thus, the location and spacing of spectral lines is unique for each atom and, therefore, enables scientists to determine what types of atoms are within a radiation source from its unique signature spectrum.

There are three types of spectra that an object can emit, namely, emission, absorption, and continuous spectra.

An emission line occurs when an electron drops down to a lower orbit around the nucleus of an atom and loses energy, thereby radiating electromagnetic waves at a particular frequency (i.e., a line of relatively intense radiation in the overall wavelength spectrum being observed). Thus, for instance, an emission spectra occurs when the atoms and molecules in a hot gas emit extra radiation at certain wavelengths, causing bright lines to appear in its spectra. The pattern of these lines is unique for each element. The position of these lines in the spectra can be used to determine the composition, temperature, density, and/or other physical properties of the object.

An absorption line, on the other hand, occurs when electrons move to a higher orbit by absorbing energy. If one shines a source of radiation on an object, it will absorb that radiation only at certain very specific frequencies, depending on the atoms that make up that object. Thus, as with emission spectra, by measuring the absorption spectrum of the radiation reflected from that object, one can determine the composition of the object by determining what wavelengths that appeared in the illumination source do not appear in the reflection. This is the absorption spectra.

Spectroscopy based on atomic spectral lines is primarily appropriate for visible wavelengths. In the near infrared (IR) range (which is roughly 0.75-3.0 microns), midwave IR range (about 3.0-8.0 microns), and longwave IR range (about 8.0-30 microns], the dominant mechanism responsible for spectral absorption bands are not transitions between electronic energy levels, but rather transitions between molecular vibrational energy levels. In the far IR range, sometimes referred to as the Terahertz or THz range (about 30-1000 microns), molecular rotational energy levels are the dominant mechanism.

There is an additional application that pertains only to THz (far IR), namely, detection and identification of solid materials based on the absorption spectra of the material's crystalline lattice vibrations (so called phonon spectrum), which lie mostly at far IR wavelengths (THz frequencies). The principle is the same, but the fundamental mechanism for spectral emissions is lattice vibrations rather than molecular vibrations or rotations. This is useful for detecting explosives, drugs, etc.

Not only can an object's composition be determined from its spectrum, but potentially also its temperature, density, and other properties, since changes in at least temperature and density can shift the signature spectral lines of an atom.

Continuous spectra (also called a thermal spectra) are emitted by any object that radiates heat, i.e., has a temperature above absolute zero. The light (or other electromagnetic radiation) is spread out into a continuous band with every wavelength having some amount of radiation. Accordingly, the magnitude of radiation at a given wavelength or wavelengths may be used to determine the general composition of an object and/or its temperature or density. The continuous spectra of objects, however, generally tend to provide less information than the more specific emission or absorption spectra.

Accordingly, spectroscopy and spectrometers have powerful important applications across many fields of science and technology. For example, spectroscopy and spectrometers are used extensively in astronomy to determine the composition of stars and other objects in space. Spectroscopy and spectrometers also are used in military and security applications, such as in the identification of substances that might be inside of buildings, underground, or otherwise not directly observable. Spectrometers also can be used to scan persons and luggage (at airports, for instance) to determine if the person is carrying (or the luggage contains) certain types of items, such as plastic explosives or metal objects, such as firearms.

A non-imaging spectrometer observes the spectral components of all the radiation from a given source as a single unit. On the other hand, an imaging spectrometer separately detects the radiation from different points in a given field of view and determines the spectral components for each of those points separately (i.e., pixelation). Thus, for instance, a non-imaging spectrometer may employ a single photodetector for detecting the radiation from an object, whereas an imaging spectrometer would comprise an array of photodetectors, each receiving radiation from a different portion or point within the overall field of view being observed.

Various techniques are known for breaking radiation into its spectral components. Perhaps the most well-known example of this is passing sunlight through a prism. Another example, is a Michelson spectrometer, in which radiation is passed through a beam splitter in order to split it into two separate beams having the same properties and then causing those two separate beams to be recombined after they travel over paths of different lengths. Because of the different lengths of the two paths, the radiation from one beam will be phase shifted relative to the radiation from the other beam, thus causing an interference pattern when the two beams are recombined. The interference pattern can be analyzed to determine the spectral components of the original single beam. An instrument that causes interference between two radiation beams is called an interferometer.

Another interferometric technique for splitting radiation into two components with different phase delays and then recombining them is a lamellar grating interferometer. The lamellar grating interferometer was first described by John Strong, Journal of Optical Society of America, Vol. 57, pp. 354-7 (1957). A summary of the operation and design issues of a lamellar grating interferometer can be found in chapter fifteen of the book Introductory Fourier Transform Spectroscopy (Academic Press, New York, 1972) by Robert John Bell. Furthermore, Omar Manzado et al., “Miniature lamellar grating interferometer based on silicon technology”. Optics Letters, Vol. 29, No. 13, Jul. 1, 2004, pp. 1437-9, incorporated herein by reference, discloses a lamellar grating interferometer fabricated using MEMS (micro-electro-mechanical systems) technology for use at near infrared wavelengths.

It is an object of the present invention to provide an improved spectrometer.

It is another object of the present invention to provide a spectrometer with application in the near infrared to far infrared (Terahertz frequencies) wavelength spectrum in smaller sub-bands.

### SUMMARY OF THE INVENTION

In accordance with the principles of the invention, a lamellar grating interferometer breaks the radiation down into its wavelength components. The two sets of teeth of the grating are moved relative to each other. The spectral output of the interferometer is focused on an array of detectors and data is stored for a large number of relative displacements of the grating teeth. The collected data is then Fourier transformed to recover the spectrum of the radiation.

In a preferred embodiment of the invention, the detector array comprises an uncooled, microbridge detector array. In another preferred embodiment, the detector array comprises solid-state photodetectors. In yet another preferred embodiment, the detector array comprises semiconductor MEMS devices.

Recent advances in micro electro mechanical system technology (MEMS) enable the fabrication of dynamically programmable lamellar gratings. A MEMS lamellar grating combined with an uncooled microbridge detector array permits the fabrication of an extremely compact and lightweight spectrometer in accordance with the principles of the present invention.

### BRIEF DESCRIPTION OF THE DRAWINGS

FIG. 1 is a schematic diagram of a spectrometer in accordance with the principles of the present invention.

FIG. 2 is a more detailed schematic view of the lamellar grating interferometer of FIG. 1.

FIGS. 3A-3D comprise four spectral analyses illustrating measured and predicted spectra at terahertz frequencies of common chemical compounds used in explosives showing the unique spectral “fingerprints” which can be measured with a spectrometer.

FIG. 4 is a schematic diagram of an alternative embodiment of a spectrometer in accordance with the principles of the present invention.

FIGS. 5A-5C are perspective views of an exemplary implementation of a lamellar grating interferometer for a Terahertz frequency application of the present invention.

FIG. 6 illustrates an exemplary imaging optical system suitable for use with uncooled detectors showing one possible approach for incorporating a lamellar grating interferometer in the system.

### DETAILED DESCRIPTION OF THE INVENTION

The invention is a spectrometer that has application in the near infrared to far infrared (or THz) wavelength range. As a practical matter, a particular spectrometer constructed in accordance with the principles of the present invention would probably have a frequency range encompassing only a portion of the near infrared to Terahertz wavelength range; the more important point being that one can employ the principles of the present invention to produce a spectrometer that operates in a sub-band anywhere within the near infrared to Terahertz frequency range. In the prior art, the type of spectrometer and the technology used within it typically had to be vastly different depending on the particular wavelength range over which the spectrometer was to operate. In accordance with the principles of the present invention, the same basic technology and techniques can be used to create spectrometers that operate in a frequency band anywhere from near infrared (approximately 0.75-3.0 microns), through mid-wave infrared (approximately 3.0-8.0 microns) and long-wave infrared (approximately 8.0-30 microns), to far infrared (THz) (approximately 30-1000 microns).

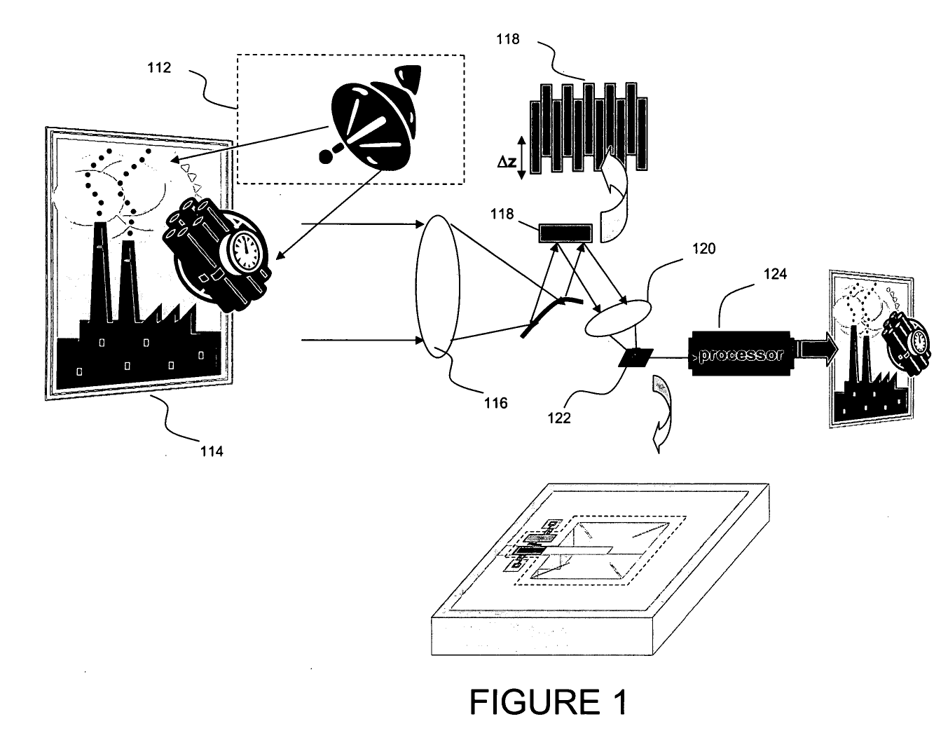

FIG. 1 is a schematic diagram of the basic components of a Terahertz range two-dimensional imaging Fourier transform spectrometer 101 in accordance with the principles of the present invention. This type of system may have application in airport security for scanning persons or luggage for explosives, firearms, and other contraband items. An illumination source 112 illuminates an object or scene 114 (hereinafter generically “object”) the composition of which it is desired to know. The object may be a piece of luggage, a person, and/or a portion of a factory. As a practical matter, the luggage or person probably would have to be positioned in a particular location in which they could be illuminated by the radiation source 112, such as a booth or similar closed space. The illumination source 112 should emit radiation containing a given distribution of radiation at all frequencies within the bandwidth of the spectrometer. However, this is not a requirement of the system.

With the active illumination source 112, the object will absorb radiation from source 112 and thus modify the spectrum of the reflected radiation and modify the structure of the radiation reflected by the object. As previously noted, the object will have a particular absorption spectrum based on the atoms and molecules that make up that object. The radiation from the illumination source 112 that is reflected off of the object 114 is collected by an optical system 116 and brought to bear upon a lamellar grating interferometer 118. The optical system 116 can be a conventional reflective, refractive, or catadioptric design.

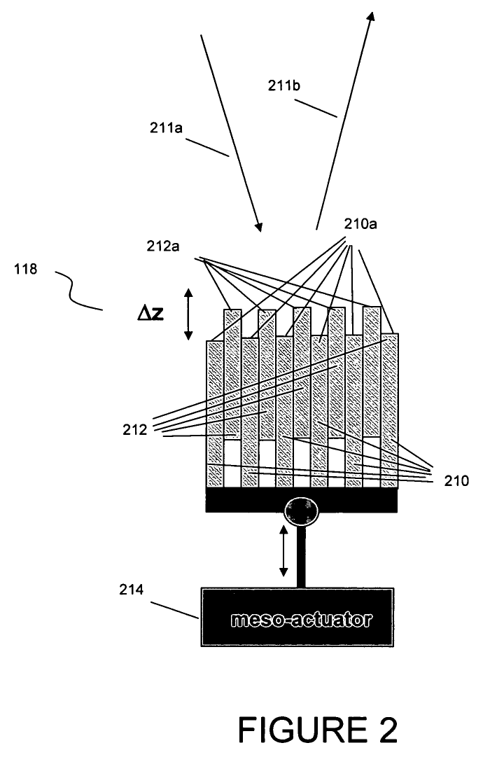

FIG. 2 is a more detailed schematic diagram of a lamellar grating interferometer in accordance with the principles of the present invention that may be used in the spectrometer 101 of FIG. 1. As shown, the grating 118 comprises a first set of teeth 210 and a second set of teeth 212. The front facets 210a of teeth 210 are all positioned evenly with each other in the same plane. The front facets 212a of teeth 212 are all positioned evenly with each other in the same plane. The second set of teeth 212 are movable in unison in the z direction relative to the first set of teeth 210 by a meso-scale actuator 214 so as to change the linear distance in the z direction between the front facets 210a of teeth 210 and the front facets 212a of teeth 212. In the terminology of the present specification, Δz indicates the linear offset between the front facets of the two sets of teeth. Also in the terminology of the present specification, the zero offset position is the position in which the front facets of both sets of teeth are perfectly even with each other.

This type of lamellar grating can readily be manufactured using well-known MEMS technology.

The optical system 116 directs the radiation 211a on the front facets 210a, 212a of the teeth of the lamellar grating 118. When the teeth are in the zero offset position, the lamellar grating is essentially a mirror. However, when the two sets of teeth 210, 212 are not perfectly even, reflecting radiation off of the font facets of the two sets of teeth's splits the radiation into two components, i.e., the radiation 211b that has reflected off of the front facets 210a of the first set of teeth 210 and the radiation that has reflected off of the front facets 212a of the second set of teeth 212. The radiation in the two different components, of course, are phase offset from each other.

Referring back to FIG. 1, the amount of phase offset depends on the distance Δz. The radiation reflected off of the front facets of the two sets of teeth is focused by a second optical system 120 onto a detection system 122.

The detection system 122 can be any system reasonably adapted to detect radiation in the frequency spectrum of the particular spectrometer. In an imaging spectrometer, the detector may comprise an array of detectors. It may be a two-dimensional array of detectors (for example, a grid of 100×100 photodetectors) or a one-dimensional array that is scanned over a field of view. Alternately, a fixed one-dimensional array of detectors can be employed and the object passed transversely through the field of view of the one-dimensional I detector array. Finally, the detection system may comprise only a single detector that is scanned to produce an image.

Of course, a single detector that is not scanned can be used in a simple non-imaging spectrometer.

The particular technology most suitable for fabricating the detector(s) likely will depend on the frequency range of the spectrometer, different technologies being more economically suited to different size wavelengths of radiation. In the Terahertz range, an uncooled thermal detector, such as a thermoelectric (TE) microbridge detector would be an excellent choice as a detector. Such microbridge detectors can be manufactured using MEMS technology. Some particular TE microbridge detectors that would work well in the present invention are disclosed in U.S. Pat. Nos. 5,220,188, 5,220,189, 5,449,910, and 6,036,872, owned by the same assignee as the present patent application. In the near infrared frequency range, the detector or detector array might comprise photoelectric detectors using either the photoconductive effect or photovoltaic effect. U.S. Pat. No. 5,220,188 discloses a basic etch-pit type of microbolometer IR detector. U.S. Pat. No. 5,220,189 discloses a basic thermoelectric (TE) type IR detector, which would be preferred for the present application. Subsequent improvements to these designs are described in, for instance, U.S. Pat. Nos. 5,449,910, 5,534,111, 5,895,233, and 6,036,872.

In any event, the detector(s) convert the radiation signals into electrical signals, which are fed into a processing unit 224 for processing, storage, and analysis.

In operation, the two sets of teeth 210 and 212 of the lamellar grating interferometer 118 are scanned relative to each other to a plurality of different Δz positions, possibly including Δz=0. At each of the Δz positions, the processor 124 receives and stores the data from the detector array 122. After a full scan of all desired Δz positions has been conducted and the collected data stored, the processor 124 performs a Fourier transform on the data set from each pixel and determines the spectral data for each pixel of the array. This procedure is well known in the art of Fourier transform spectroscopy, as described for example in the book Introductory Fourier Transform Spectroscopy (Academic Press, New York, 1972) by Robert John Bell.

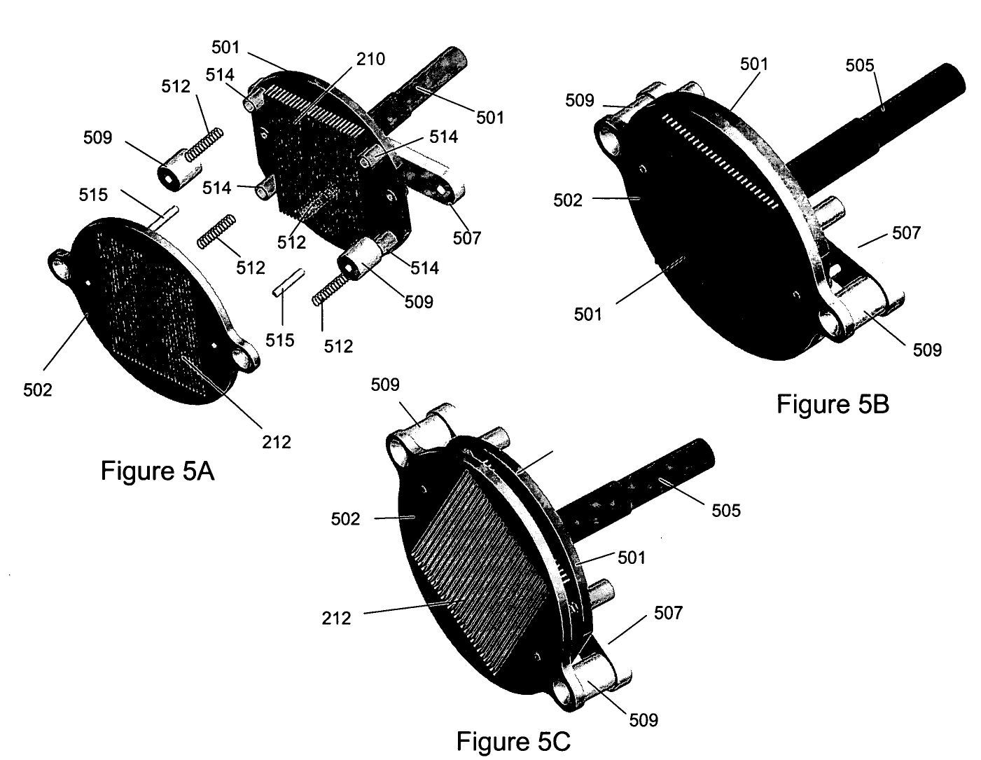

FIG. 5A is an exploded view of an exemplary lamellar grating interferometer that can be used in a Terahertz frequency application of the present invention. FIGS. 5B and 5C show the same interferometer in its assembled form with the two sets of teeth at opposite extremes of their relative travel range, respectively. A similar structure can be used at other spectral wavebands of interest by scaling the grating period and other physical parameters appropriately to the wavelength.

The two sets of teeth 210 and 212 are disposed on separate substrate 501 and 502, respectively. One of the substrates 501 is mounted on a motor-actuated arm 505 that can move the substrate in the longitudinal direction of the arm so as to alter the longitudinal distance between the front faces of the two sets of teeth. The other substrate 502 is fixedly mounted to a transverse support member 507 via spacers 509 and suitable attachment means, such as screws or bolts (not shown). Additionally, springs 512 are mounted in hollow cylinders 514 that run between the two substrates 501 and 502 in order to bias the two substrates apart from each other. Finally, alignment guides 515 pass through holes in the edges of the two substrates 501, 502 to help maintain the alignment of the two substrates both longitudinally (i.e., to keep the two substrates parallel with each other) and transversely (to keep the two sets of teeth aligned so that one set of teeth passes through the gaps in the other set of teeth without interference. As shown, the two substrates are aligned so that the teeth 210 of substrate 501 can pass through the gaps between the teeth 212 in substrate 502. The motor actuated arm 505 can be used to change the relative distance between the two substrates 501, 502 and thus the relative distance between the front faces of the two sets of teeth 210, 212. FIG. 5B shows the condition of the lamellar grating interferometer with the arm fully extended to the maximum positive ΔZ position. FIG. 5C shows the condition of the interferometer with the arm fully withdrawn to its maximum negative ΔZ position.

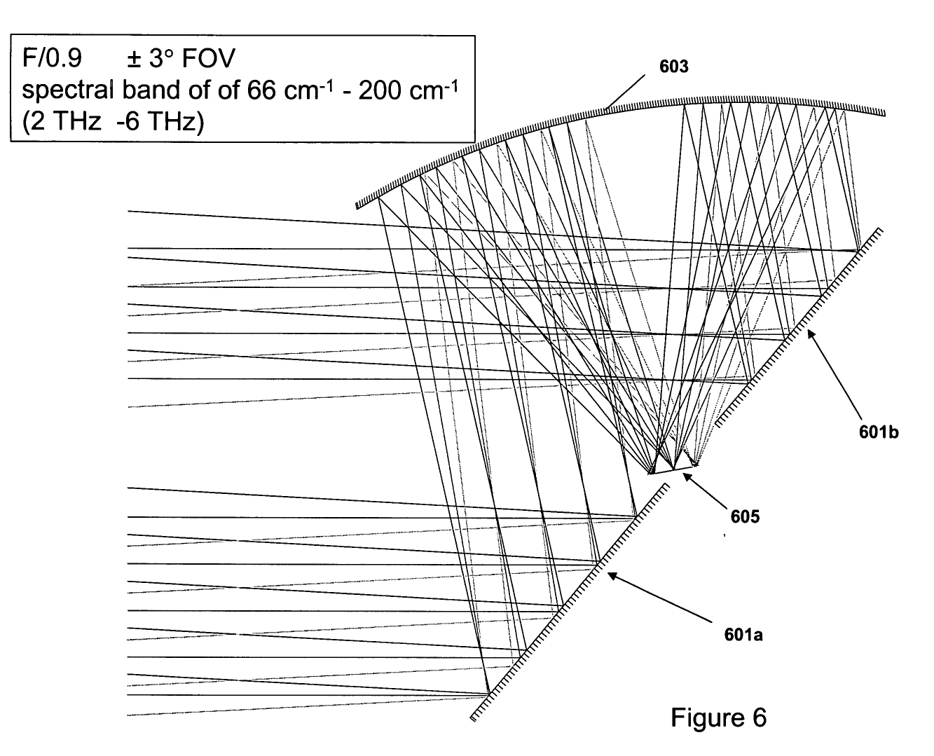

FIG. 6 illustrates one exemplary imaging optical system suitable for use with uncooled detectors showing one possible approach for incorporating a lamellar grating interferometer in the system. In the illustrated system, the incoming radiation is reflected off of two lamellar grating interferometers 601a and 601b towards a focusing mirror 603. The radiation is reflected off of the mirror 603 into the uncooled detector array 605.

How the spectral image obtained by the detector array is then further analyzed (either in the processor 124 or in subsequent processing equipment (not shown)) depends on the particular application. Merely as an example, if the spectrometer is being used as an airport security system for scanning individuals for prohibited items, then the data might be analyzed to determine if a person has plastic explosives, metal, or poisonous gas on his or her person. This would be done by analyzing the emission and/or absorption line spectral image of the person for the signature spectral image of the atoms or molecules making up such substances.

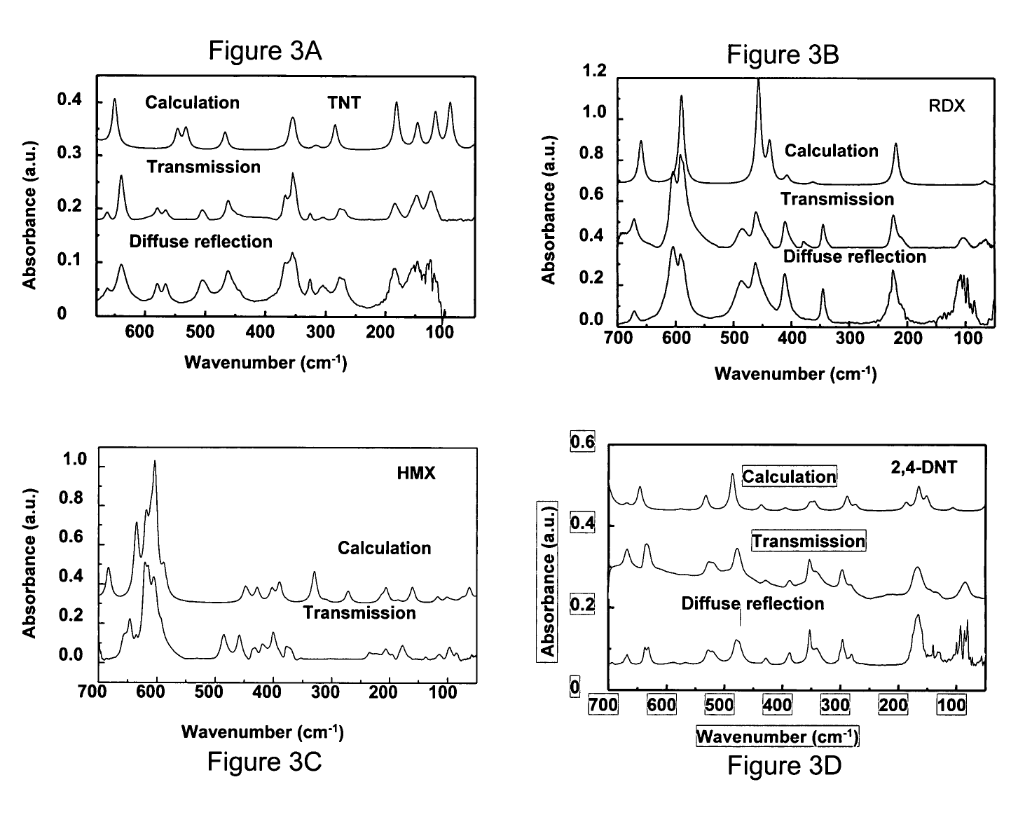

Examples of spectra of typical explosive compounds at THz frequencies are illustrated in FIGS. 3A-3D. FIG. 3A shows the spectra for TNT. FIG. 3B shows the spectra for RDX. FIG. 3C shows the spectra for HMX. FIG. 3D shows the spectra for 2,4-DNT.

The spectrometer of FIG. 1 also can be used to obtain broadband, nonspectral images of objects, either using the illumination source 112 or simply using the ambient light and other radiation in the vicinity of the spectrometer 101.

In one preferred embodiment of the invention, the spectrometer may first be used to obtain and analyze a broadband image of a person or object data. (For a broadband image, the teeth of the lamellar grating would be set to Δz=0). Then, if any portion of the image (i.e., any portion of the individual under observation) appears to have an unusual broadband reading, then only that portion of the image can be analyzed for its absorption and/or emission spectrum by subsequently scanning the lamellar grating interferometer. Merely as an example, radiation in the wavelength range of about 0.1 to 0.3 mm is able to permeate about a millimeter of clothing and differentiate between the broadband reflectivity of human skin, on the one hand, and metal or plastic explosives, on the other hand. Thus, for instance, if the broadband image reveals that a person is concealing an object under his shirt, then that portion of the image can then be re-processed to obtain the more complex and detailed emission and/or absorption spectra and to determine the composition of that object.

With current technology and assuming pragmatic parameters such as a 100×100 detector, with 300 micron pixel size providing a spatial resolution of 1.75 cm² at about 10 meters, for instance, a commercially reasonably priced spectrometer for the airport security market might be able to obtain a broadband image every 1/30^{th} of a second. On the other hand, an emission or absorption spectral image of the same size and assuming approximately 128 frequency bands might require on the order of four to five seconds per image.

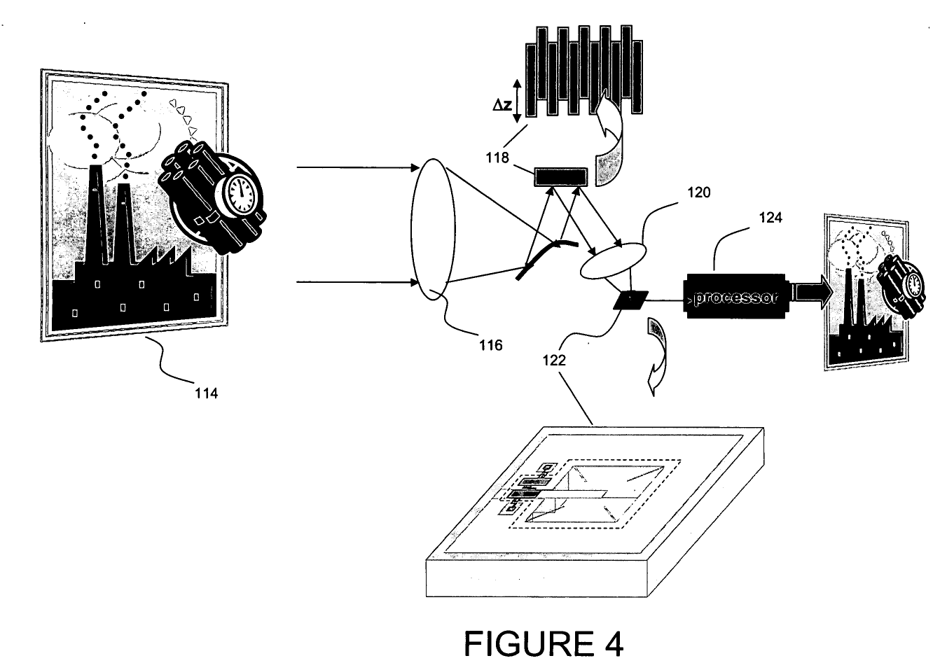

FIG. 4 illustrates an alternative embodiment of the invention. This embodiment of the invention is essentially identical to the embodiment of FIG. 1 except for the omission of the illumination source 112. This embodiment uses only passive illumination (the ambient light and other radiation). This embodiment, while not preclusive of performing emission and/or absorption spectral analysis, is most suitable for broadband imaging. A spectrometer with no illumination source employing the principles of the present invention could be used practically as a stand-off continuous spectrum spectrometer with a range of about 100 to 1000 meters, depending on the specific spectral band.

As a practical matter, any given spectrometer created in accordance with the principles of the present invention will operate only in a small portion of the near infrared to Terahertz range. A practical frequency bandwidth of any given implementation would likely cover a bandwidth no greater than about ½λₒ to about 1.5 λₒ, where λₒ is the center wavelength of the band.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A spectrometer comprising:
a lamellar grating interferometer;
a first optical system adapted to direct radiation from an object onto said interferometer;
an array of detector elements for detecting said radiation after it has passed through said interferometer and converting said detected radiation into electrical signals, each detector adapted to detect light from a different portion of said object; and
a processor coupled to receive said electrical signals containing information as to the spectral composition of said radiation from said detector elements, said processor adapted to perform a Fourier transform on said information to obtain a spectral composition of said object.

2. The spectrometer of claim 1 further comprising:
a radiation source adapted to illuminate said object.

3. The spectrometer of claim 1 wherein said detectors of said detector array comprise uncooled thermal detectors.

4. The spectrometer of claim 1 wherein said detectors of said detector array comprise microbridge bolometers.

5. The spectrometer of claim 1 wherein said detectors of said detector array comprise thermoelectric microbridge detectors.

6. The spectrometer of claim 1 wherein said detectors of said detector array comprise photoelectric detectors using either the photoconductive or photovoltaic effects.

7. The spectrometer of claim 1 wherein said detectors of said detector array comprise MEMS devices.

8. The spectrometer of claim 1 further comprising a control system, said control system adapted to cause said spectrometer to obtain a continuous spectrum spectral analysis of said object and, responsive to said continuous spectrum spectral analysis for any portion of said object meeting certain predefined conditions, obtain an emission, absorption, or reflection spectral analysis of said portion of said object.

9. The spectrometer of claim 1 wherein said spectrometer has a bandwidth within the near infrared to terahertz range.

10. The spectrometer of claim 9 wherein said spectrometer has a bandwidth between 0.5 f₀ and 1.5 f₀, where f₀ is the center frequency of the spectral band for a particular application.

11. A method of obtaining a spectral analysis of an object, said method comprising the steps of:
introducing radiation from said object into a lamellar grating interferometer;
detecting said radiation after it has passed through said interferometer with an array of detector elements, each detector adapted to detect light from a different portion of said object
converting said detected radiation into electrical signals containing spectral information about said object; and
performing a Fourier transform on said information to obtain a spectral composition of said object;
analyzing said spectral composition of said object to obtain information about physical properties of said object.

12. The method of claim 11 further comprising the step of:
illuminating said object with a radiation source.

13. The method of claim 12 wherein said detecting step comprises detecting with a plurality of uncooled thermal detectors.

14. The method of claim 12 wherein said detecting step comprises detecting with a plurality of microbridge bolometers.

15. The method of claim 12 wherein said detecting step comprises detecting with a plurality of microbridge thermoelectric detectors.

16. The method of claim 12 wherein said detecting step comprise detecting with a plurality of photoelectric detectors.

17. The method of claim 12 further comprising the step of:
obtaining a continuous spectrum spectral analysis of said object; and
responsive to said continuous spectrum spectral analysis for any portion of said object meeting certain predefined conditions, obtaining an emission or absorption spectral analysis of said portion of said object.
